(19) United States
(12) Patent Application Publication
(10) Pub. No.: US 2020/0384953 A1
(43) Pub. Date: Dec. 10, 2020

(54) ON-BOARD DEVICE AND PERSONAL INFORMATION MANAGEMENT SYSTEM

(71) Applicant: KABUSHIKI KAISHA TOKAI RIKA DENKI SEISAKUSHO, Aichi (JP)

(72) Inventors: Yosuke OHASHI, Aichi (JP); Rijin OWAKI, Aichi (JP); Fumitaka YOSHIKAWA, Aichi (JP)

(21) Appl. No.: 16/767,384

(22) PCT Filed: Nov. 16, 2018
(86) PCT No.: PCT/JP2018/042578

§ 371 Date: May 27, 2020

(30) Foreign Application Priority Data
Dec. 4, 2017 (JP) 2017-232373

(51) Int. Cl. B60R 25/25; B60R 25/24; G06F 21/62; G06F 21/32

(52) U.S. Cl. CPC B60R 25/25; G06F 21/32; G06F 21/6245; B60R 25/24

(57) ABSTRACT

An on-board device includes a storage unit that stores personal information of a user of a vehicle, and a control unit that deletes the personal information of the user stored in the storage unit, based on an input of an instruction signal that is output when relevant information associating information of the vehicle with information of the user of the vehicle is updated.

### CROSS-REFERENCES TO RELATED APPLICATIONS

The present patent application claims the priority of Japanese patent application No. 2017/232373 filed on Dec. 4, 2017, and the entire contents of Japanese patent application No. 2017/232373 are hereby incorporated by reference.

### TECHNICAL FIELD

The present invention relates to an on-board device and a personal information management system.

### BACKGROUND ART

A vehicle anti-theft device is known, which is provided with a mobile device authentication means which authenticates a mobile device based on identification information received from the mobile device, a driver authentication means which acquires driver identification information unique to a driver and authenticates the driver as a pre-registered driver based on comparison with pre-registered driver identification information, an information input means receiving an input of setting information which is information set by the registered driver, and an authentication control means which selects either authentication using the driver authentication means or authentication based on the setting information input by the registered driver and controls start of a vehicle based on an authentication result from the selected authentication and an authentication result provided by the mobile device authentication means (see, e.g., Patent Literature 1).

This vehicle anti-theft device uses biometric information of the driver as the driver identification information.

### CITATION LIST

### Patent Literature

Patent Literature 1: JP 2010/208554 A

### SUMMARY OF INVENTION

### Technical Problem

The vehicle anti-theft device disclosed in Patent Literature 1 has a problem that when, e.g., the owner of the vehicle changes, personal information such as biometric information of a previous owner, which has been left undeleted, is left in the vehicle.

It is an object of the invention to provide an on-board device and a personal information management system which are capable of deleting personal information left undeleted after an owner of a vehicle has changed.

### Solution to Problem

According to an embodiment of the invention, an on-board device comprises: a storage unit that stores personal information of a user of a vehicle; and a control unit that deletes the personal information of the user stored in the storage unit, based on an input of an instruction signal that is output when relevant information associating information of the vehicle with information of the user of the vehicle is updated.

According to another embodiment of the invention, a personal information management system comprises: a registration device in which relevant information associating information of a vehicle with information of a user of the vehicle is registered; and an on-board device that comprises a storage unit storing personal information of the user of the vehicle, and a control unit that deletes the personal information of the user stored in the storage unit in response to an instruction signal that is output when the relevant information is updated in the registration device.

### Advantageous Effects of Invention

According to an embodiment of the invention, it is possible to provide an on-board device and a personal information management system which are capable of deleting personal information left undeleted after an owner of a vehicle has changed.

### BRIEF DESCRIPTION OF DRAWINGS

FIG. 1A is a block diagram illustrating an on-board device in an embodiment.

FIG. 1B is an explanatory diagram illustrating a table stored in the on-board device in the embodiment.

FIG. 2A is an explanatory diagram illustrating a personal information management system in an embodiment.

FIG. 2B shows a management table in the embodiment before updating.

FIG. 2C shows the management table in the embodiment after updating.

FIG. 3 is a flowchart showing an operation of the on-board device in the embodiment.

### DESCRIPTION OF EMBODIMENTS

### Summary of the Embodiments

An on-board device in an embodiment has a storage unit that stores personal information of a user of a vehicle, and a control unit that deletes the personal information of the user stored in the storage unit in response to an instruction signal that is output when relevant information associating information of the vehicle with information of the user of the vehicle is updated in a registration device in which the relevant information is registered.

The on-board device deletes personal information left in a vehicle in response to an instruction signal which is output due to updating of relevant information in the registration device. Therefore, unlike when such a configuration is not adopted, personal information left undeleted can be deleted after an owner of a vehicle has changed.

A personal information management system in another embodiment has a registration device in which relevant information associating information of a vehicle with information of a user of the vehicle is registered, and an on-board device that comprises a storage unit storing personal information of a user of a vehicle and a control unit that deletes the personal information of the user stored in the storage unit in response to an instruction signal that is output when the relevant information is updated in the registration device.

This personal information management system deletes personal information left in a vehicle by an instruction signal which is output due to updating of the relevant information in the registration device. Therefore, unlike when such a configuration is not adopted, personal information left undeleted can be deleted after an owner of a vehicle has changed.

### EMBODIMENTS

### (General Configuration of On-Board Device 1)

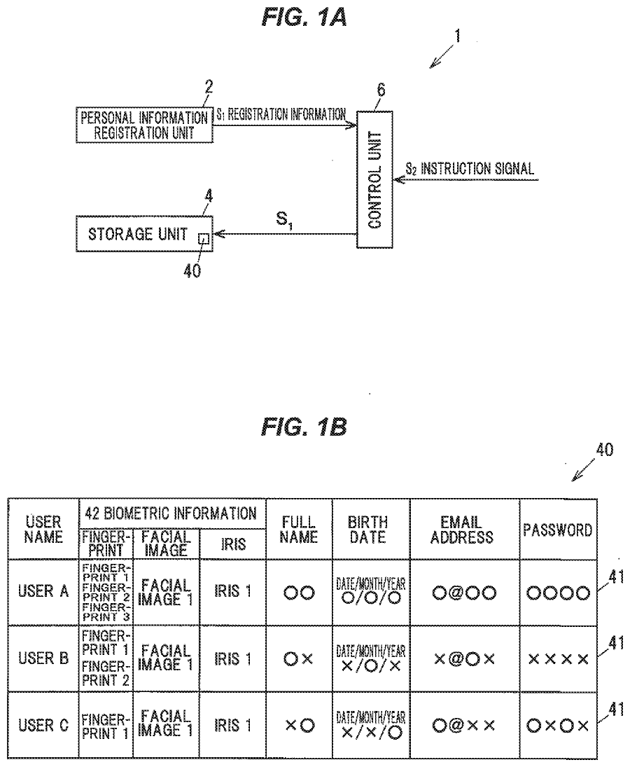

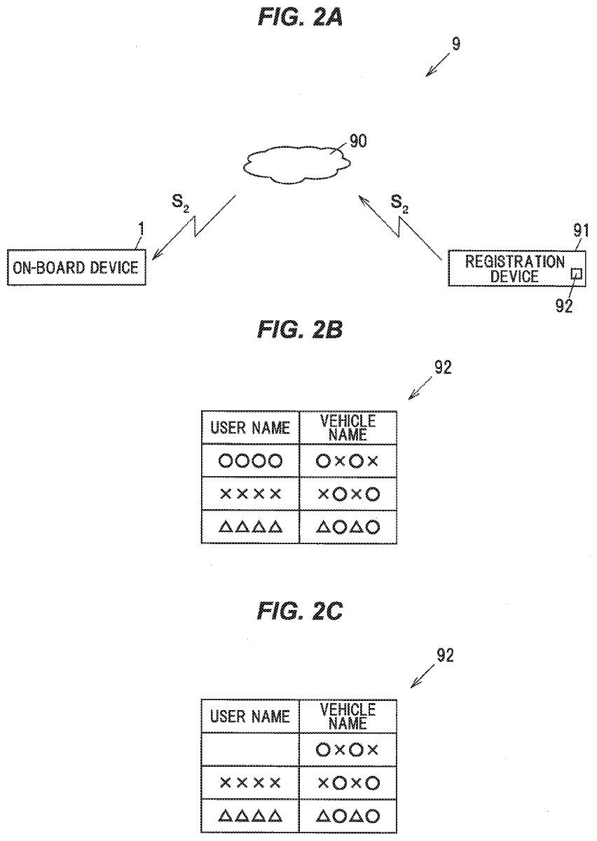

FIG. 1A is a block diagram illustrating an on-board device in an embodiment, and FIG. 1B is an explanatory diagram illustrating a table stored in the on-board device in the embodiment. FIG. 2A is an explanatory diagram illustrating a personal information management system in an embodiment, FIG. 2B shows a management table in the embodiment before updating, and FIG. 2C shows the management table in the embodiment after updating. In FIGS. 1A and 2A, flows of main signals and information are indicated by arrows.

An on-board device 1 is mounted on a vehicle to manage personal information 41 of users including the owner of the vehicle. The vehicle here is used by, e.g., plural users (User A to User C, as an example), as shown in FIG. 1B.

Meanwhile, in a personal information management system 9, e.g., a management table 92 associating sold vehicles and owners thereof is generated and managed in a server (e.g., a registration device 91) installed in a vehicle retailer such as dealer, as shown in FIGS. 2A and 2B.

The on-board device 1 has, e.g., a storage unit 4 which stores the personal information 41 of the users of the vehicle, and a control unit 6 which deletes the personal information 41 of the users stored in the storage unit 4 in response to an instruction signal S2 which is output when relevant information (the management table 92) associating information of the vehicle with information of the users is updated in the registration device 91 in which the management table 92 is registered, as shown in FIGS. 1A to 2C.

Meanwhile, the personal information management system 9 has, e.g., the registration device 91 in which the management table 92 associating information of the vehicle with information of the users of the vehicle is registered, and the on-board device 1 provided with the storage unit 4 storing the personal information 41 of the users of the vehicle and the control unit 6 which deletes the personal information 41 of the users stored in the storage unit 4 in response to the instruction signal S2 which is output due to updating of the management table 92 in the registration device 91, as shown in FIGS. 2A to 2C.

The personal information 41 of each user includes at least biometric information 42 of the user. As an example, the biometric information 42 includes fingerprint, vein, facial image, iris, etc., used to create a biometric authentication template.

The on-board device 1 is further provided with, e.g., a personal information registration unit 2 which receives registration of the personal information 41, as shown in FIG. 1A.

The personal information management system 9 enables, e.g., exchange of signals such as the instruction signal S2 and information via a cloud 90, as shown in FIG. 2A.

The cloud 90 is, e.g., a server on a network which allows signals and information to be exchanged wirelessly and reciprocally.

### (Configuration of the Personal Information Registration Unit 2)

The personal information registration unit 2 is used to register the personal information 41. As an example, the personal information registration unit 2 is configured to register user's information such as fingerprint, facial image, iris, full name, birth date, email address, password, etc., as shown in FIG. 1B. However, registrable information is not limited thereto and may include vein, pulse rate, blood pressure or residential address, etc.

Text data such as full name, birth date and email address is registered using a touchpad or a virtual keyboard, etc. Biometric information such as fingerprint, facial image, iris is registered, e.g., as follows.

Fingerprint is registered using, e.g., a sensor configured to read the fingerprint pattern, such as optical, capacitive, electrical field intensity measurement, pressure-sensitive, or thermal, etc.

Vein of an operating finger or palm is registered using, e.g., a sensor configured to read the vein pattern based on reflection of emitted infrared light.

Facial image is registered using, e.g., a sensor configured to read an uneven shape on a subject based on depths at plural measurement points on the captured subject.

Iris is registered using, e.g., a sensor configured to read an iris by emitting infrared light and processing the captured image.

The personal information registration unit 2 generates and outputs, e.g., registration information S₁ based on information to be registered.

### (Configuration of the Storage Unit 4)

The storage unit 4 is constructed from, e.g., a HDD (Hard Disk Drive) or a semiconductor memory, etc. The storage unit 4 in the present embodiment is a semiconductor memory. This semiconductor memory may be a RAM mounted on the control unit 6.

The storage unit 4 is configured to generate, e.g., a table 40 based on the registration information S₁ acquired from the personal information registration unit 2, as shown in FIGS. 1A and 1B.

The table 40 contains, e.g., the personal information 41 including the biometric information 42 associated with each user, as shown in FIG. 1B. In FIG. 1B, the personal information 41 of the user A to the user C, who share the vehicle, are shown as an example.

### (Configuration of the Control Unit 6)

The control unit 6 is, e.g., a microcomputer composed of a CPU performing calculation and processing, etc., of the acquired data according to a stored program, and a RAM and a ROM which are semiconductor memories. The ROM stores, e.g., a program for operation of the control unit 6. The RAM is used as, e.g., a storage area for temporarily storing calculation results, etc. The control unit 6 also has, inside thereof, a means for generating a clock signal and operates based on the clock signal.

When the instruction signal S2 output from the registration device 91 is input via the cloud 90, the control unit 6 deletes the left personal information 41 by controlling the storage unit 4. For example, the personal information 41 of a previous owner, when left in the vehicle, may be abused or may remain as a candidate biometric information 42 for authentication and result in that authentication takes long time. Due to updating of the management table 92, i.e., by receiving an input of the instruction signal S2 indicating that the owner of the vehicle has changed, the control unit 6 deletes the personal information 41 which has been left undeleted.

For example, as a method of deleting the personal information 41, the control unit 6 initializes the table 40. The control unit 6 deletes, e.g., all personal information 41 registered by the user A to the user C shown in FIG. 1B.

### (Configuration of the Registration Device 91)

The registration device 91 is provided with, e.g., the management table 92 in which at least the name of the vehicle user and the vehicle name are associated.

When, e.g., registration of a user name (∘∘∘∘) is deleted as shown in FIGS. 2B and 2C, i.e., when information associating the user name with the vehicle name is updated, the registration device 91 outputs the instruction signal S2 via the cloud 90 to the vehicle involved in the deletion of registration. This vehicle is, e.g., a vehicle which has a vehicle name (∘×∘×) associated with the user name (∘∘∘∘). The updating of the management table 92 here means deletion of registration involving the vehicle to which the instruction signal S2 is output, or user name update indicating that the owner of the vehicle has changed.

The instruction signal S2 gives an instruction to delete the personal information 41 left in the storage unit 4 of the on-board device 1. In response to an input of the instruction signal S2, the on-board device 1 initializes the table 40 including the information 41 left in the storage unit 4.

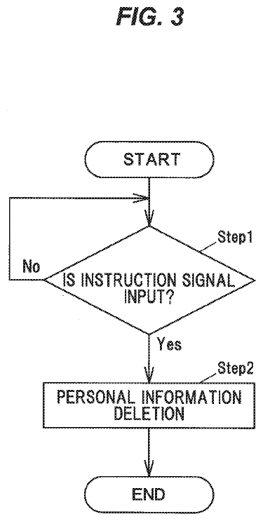

An example of an operation of the on-board device 1 in the present embodiment will be described below along with the flowchart in FIG. 3.

### (Operation)

When it is “Yes” in Step 1, i.e., when the instruction signal S2 is input via the cloud 90 (Step 1: Yes), the control unit 6 of the on-board device 1 deletes all personal information 41 of the table 40 left in the storage unit 4 (Step 2) and ends the process.

### Effects of the Embodiments

The on-board device 1 in the present embodiment can delete the personal information 41 left undeleted after an owner of a vehicle has changed. In detail, in response to the instruction signal S2 which is output due to updating of the management table 92 in the registration device 91, the on-board device 1 deletes the personal information 41 which is left in the vehicle. Therefore, unlike when such a configuration is not adopted, the personal information 41 left undeleted can be deleted after an owner of a vehicle has changed. Since the on-board device 1 can delete the personal information 41 which has been left undeleted, user's privacy is protected.

The on-board device 1 can delete not only the personal information 41 but also the biometric information 42 included in the personal information 41 and thus can prevent abuse of the biometric information 42, unlike when biometric information is not deleted and left in the vehicle.

In the on-board device 1, if the biometric information 42 of a previous owner is left even though the owner of the vehicle has changed, this unnecessary biometric information 42 is still used at the time of authentication by verification of the biometric information 42 and this may cause an increase in authentication time. However, since the on-board device 1 can delete the biometric information 42 which has been left undeleted, it is possible to prevent an increase in authentication time.

When the management table 92 is updated in the registration device 91, the personal information management system 9 outputs the instruction signal S2 via the cloud 90 to the on-board device 1 and thereby deletes the personal information 41 left in the vehicle. Therefore, unlike when such a configuration is not adopted, the personal information 41 left undeleted can be deleted after an owner of a vehicle has changed. Since the personal information management system 9 can delete the personal information 41 which has been left undeleted, user's privacy is protected.

The personal information management system 9 can delete not only the personal information 41 but also the biometric information 42 included in the personal information 41 and thus can prevent abuse of the biometric information 42, unlike when biometric information is not deleted and left in the vehicle.

Since the personal information management system 9 can delete the biometric information 42 which has been left undeleted, it is possible to prevent an increase in authentication time of the vehicle.

Although the embodiments of the invention have been described, the embodiments are merely an example and the invention according to claims is not to be limited thereto. The new embodiments may be implemented in various other forms, and various omissions, substitutions and changes, etc., can be made without departing from the gist of the invention. In addition, all combinations of the features described in the embodiments are not necessary to solve the problem of the invention. Further, the embodiments are included within the scope and gist of the invention and also within the invention described in the claims and the range of equivalency.

### REFERENCE SIGNS LIST

1 ON-BOARD DEVICE
2 PERSONAL INFORMATION REGISTRATION UNIT
4 STORAGE UNIT
6 CONTROL UNIT
9 PERSONAL INFORMATION MANAGEMENT SYSTEM
40 TABLE
41 PERSONAL INFORMATION
42 BIOMETRIC INFORMATION
91 REGISTRATION DEVICE

1. An on-board device, comprising:
a storage unit that stores personal information of a user of a vehicle; and
a control unit that deletes the personal information of the user stored in the storage unit, based on an input of an instruction signal that is output when relevant information associating information of the vehicle with information of the user of the vehicle is updated.

2. The on-board device according to claim 1, wherein at least biometric information of the user is stored as the personal information of the user in the storage unit.

3. The on-board device according to claim 2, wherein one or more selected from fingerprint, vein, pulse rate, blood pressure, facial image and iris is/are stored as the biometric information of the user in the storage unit.

4. The on-board device according to claim 1, further comprising a personal information registration unit that receives registration of the personal information of the user,
wherein the personal information of the user acquired from the personal information registration unit is stored in the storage unit.

5. The on-board device according to claim 4, wherein the personal information registration unit resisters at least biometric information of the user as the personal information of the user, and the at least biometric information of the user acquired from the personal information registration unit is stored as the personal information of the user in the storage unit.

6. The on-board device according to claim 5, wherein the personal information registration unit registers one or more selected from fingerprint, vein, pulse rate, blood pressure, facial image and iris as the biometric information of the user, and one or more selected from the fingerprint, the vein, the pulse rate, the blood pressure, the facial image and the iris is/are stored as the biometric information of the user in the storage unit.

7. The on-board device according to claim 2, wherein the storage unit generates a table that associates the personal information of the user including the biometric information of the user with each user sharing the vehicle.

8. The on-board device according to claim 7, wherein, based on the instruction signal output due to updating of the relevant information, the control unit deletes personal information of all users sharing the vehicle stored in the storage unit.

9. A personal information management system, comprising:
a registration device in which relevant information associating information of a vehicle with information of a user of the vehicle is registered; and
an on-board device that comprises a storage unit storing personal information of the user of the vehicle, and a control unit that deletes the personal information of the user stored in the storage unit in response to an instruction signal that is output when the relevant information is updated in the registration device.

10. The personal information management system according to claim 9, wherein the on-board device comprises a personal information registration unit that receives registration of the personal information of the user, and the personal information of the user is stored in the storage device based on registration information acquired from the personal information registration unit.

11. The on-board device according to claim 3, wherein the storage unit generates a table that associates the personal information of the user including the biometric information of the user with each user sharing the vehicle.

12. The on-board device according to claim 5, wherein the storage unit generates a table that associates the personal information of the user including the biometric information of the user with each user sharing the vehicle.

13. The on-board device according to claim 6, wherein the storage unit generates a table that associates the personal information of the user including the biometric information of the user with each user sharing the vehicle.
